(19) United States
(12) Patent Application Publication
(10) Pub. No.: US 2012/0015621 A1
(43) Pub. Date: Jan. 19, 2012

(54) READY CHECK SYSTEMS

(76) Inventors: Andrew Bryant Cerny, Tempe, AZ (US); Abrielle Rene Cerny, Tempe, AZ (US)

(21) Appl. No.: 12/982,045

(22) Filed: Dec. 30, 2010

Related U.S. Application Data
(60) Provisional application No. 61/348,701, filed on May 26, 2010.

(51) Int. Cl. H04W 4/22; H04W 24/00

(52) U.S. Cl. 455/404.2; 455/521

(57) ABSTRACT

Ready Check Systems is an improved communication system comprising a central computer system for initiating, integrating, and administering a remote network, a master communication unit operated remotely by a team leader, and a plurality of auxiliary communication devices preferably operated remotely by team members, wherein alert signals may be efficiently and effectively transmitted between points of interface via the remote network serving to provide a real-time safety communications system optimally suited in the event of emergency situations.

### CROSS-REFERENCE TO RELATED APPLICATION

The present application is related to and claims priority from prior provisional application Ser. No. 61/348,701, filed May 26, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The following includes information that may be useful in understanding the present invention(s). It is not an admission that any of the information provided herein is prior art, or material, to the presently described or claimed inventions, or that any publication or document that is specifically or implicitly referenced is prior art.

The present invention relates generally to the field of remotely networked communication systems and more specifically relates to a remotely networked communication system for improving the efficiency and rapidity of communication between team members operating cooperatively.

2. Description of the Related Art

Communication is a very important aspect of modern society. In the lightning fast pace of today's society, technology is judged equally by the utility in which it serves, and the amount of time that is required to accomplish it. Despite the rapid growth of technology, the field related to communication systems that may specifically assist in emergency situations is horribly lacking. Moments of crisis may only be seconds away. Whether it's a team of workers on a construction site, an international embassy amidst murky diplomatic affairs, or an operational nuclear power plant, it is imperative that communication be transmitted and received between individuals working in cooperation with one another in the most efficient and rapid means possible.

Unfortunately, despite best efforts accidents continue to occur, those caused by natural events or negligence, many resulting in unnecessary injury or loss of life due to a slow, defunct or non-existent communication system. During a potentially life or death situation, every moment counts. A communication system that is quick and efficient may be the difference in saving lives. A need exists for such a communication system.

Communication devices such as transmitters and receivers generally comprise an electronic device that may transmit and receive communication signals between at least two individuals simultaneously. Some communication systems comprise a plurality of devices that may be in wireless communication via a radio signal or a Bluetooth connection with one another. Other systems may comprise a network wherein there is a central station in communication with a plurality of secondary devices and the secondary devices are in communication solely with the central station. Lastly, there are systems usable between two entities for various forms of communication; however none of the above-mentioned communication means appear to efficiently or effectively maintain safe job-site conditions in real-time.

Various attempts have been made to solve the above-mentioned problems such as those found in U.S. Pat. No. 6,366,216 to Olesen; U.S. Pat. No. 7,027,773 to McMillin; 7,221,668 to Twitchell; and U.S. Pat. No. 5,732,074 to Spaur et al. This prior art is representative of communication systems. None of the above inventions and patents, taken either singly or in combination, is seen to describe the invention as claimed.

Ideally, a remotely networked communication system geared for an emergency condition(s) should efficiently and effectively maintain safe job-site conditions in real-time. The system would operate reliably, be user-friendly and be manufactured at a modest expense. Thus, a need exists for a reliable Ready Check System to increase the efficiency and rapidity of remote communication between team members and a team leader while operating in a cooperative relationship with one another during emergency conditions and to avoid the above-mentioned problems through pro-active prevention of these occurrences.

### BRIEF SUMMARY OF THE INVENTION

In view of the foregoing disadvantages inherent in the known communication art, the present invention provides a novel remotely networked communication system. The general purpose of the present invention, which will be described subsequently in greater detail, is to provide a remotely networked communication system for improving the efficiency and rapidity of communication between team members operating cooperatively. The present invention holds significant improvements and serves as a Ready Check System.

A ready check communication system as disclosed herein may generally comprise a central computer system, at least one remote master communication unit administered by a team leader, a plurality of auxiliary communication devices operated by at least one team member, and a rechargeable power supplier to provide rechargeable power to the plurality of ready check communication system devices.

The central computer system may be used to initialize a remote network for the secure and real-time exchange of information between various positions of interface. More specifically, the central computer system may be used to create parameters governing the remote communication between the auxiliary communication devices and the master communication unit which are in wireless communication via the remote network such that at least one real-time safety related condition may be communicated both visually and audibly to a plurality of individuals.

In a preferred method of use of ready check communication systems as described herein, the team leader is able to monitor the network and communicate between various POI devices via the central computer system. Alternatively, the team leader may monitor and communicate remotely via the master communication unit. Communications are wirelessly transmitted using integrated transmitters and transceivers housed within the master communication unit and each of the auxiliary communication device(s) which are set to a specific radio frequency.

Both the master communication unit and the auxiliary communication device(s) comprise a POI interface that provides a plurality of pushable buttons and a plurality of light emitting diodes (LED). Each button and LED is labeled using clear lettering on the POI interface to indicate what each button and LED signifies. When a team member pushes a button, a signal is wirelessly transmitted to the master communication unit. Each LED may be lit green, yellow, blue, or red, wherein each color may serve to indicate a different type of alert status. Further, the master communication unit and the auxiliary communication device(s) comprise sound producing (audibilizing) means and an alert speaker. If an emergency condition arises, such as a hazard, EMS, or HEMS condition, the alert speaker may emit a loud, more specifically a repeating alert sound as an indication to the individual of the real-time emergency condition.

The rechargeable power supplier may be used to recharge the remote devices of the present invention including the master communication unit and the auxiliary communication devices. Further, the rechargeable power supplier may comprise a USB port for all non-wireless data transfers. It should be appreciated that each of the remote devices of the ready check communication system may comprise a USB port. In a preferred method of use, a plurality of auxiliary communication devices may be ascendingly stackable in a diagonal manner in the rechargeable power supplier via a detachably connecting means.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Ready Check Communication Systems, constructed and operative according to the teachings of the present invention.

FIG. 1 shows a perspective view illustrating a central computer system in an in-use condition establishing and administering a remote network according to an embodiment of ready check communication systems.

FIG. 2 is a perspective view illustrating a master communication unit in an in-use condition being operated by a team leader according to an embodiment of the present invention.

FIG. 3 is a front perspective view illustrating the master communication unit according to an embodiment of the present invention of FIG. 2.

FIG. 4 is a perspective view illustrating an auxiliary communication device in an emergency condition as operated by a team member according to an embodiment of the present invention.

FIGS. 5A-5E shows front and back perspective views illustrating the auxiliary communication device according to an embodiment of the present invention of FIG. 4.

FIG. 6 is a front perspective view illustrating a rechargeable power station according to a preferred embodiment of the present invention.

FIG. 7 is a flowchart illustrating a network of communication between the master control unit and the auxiliary communication devices and the operable power supply of the rechargeable power station and accompanying remote devices according to an embodiment of the present invention of FIGS. 1-6.

FIG. 8 is a flowchart illustrating a central computer system interface used to control and monitor the network of communication between the master control unit and the auxiliary communication devices according to embodiments of the present invention of FIGS. 1-7.

The various embodiments of the present invention will hereinafter be described in conjunction with the appended drawings, wherein like designations denote like elements.

### DETAILED DESCRIPTION

As discussed above, embodiments of the present invention relate to a remotely networked communication system between a plurality of communication devices and more particularly to a communication system as used to improve the transmission of alert signals and other necessary communications between a team of individuals during an emergency situation which may serve to prevent unnecessary injury or loss of life. In telecommunications, a Point of Interface (POI) may be used to show the physical interface between two different carriers, such as a local exchange carrier and a wireless carrier. As used herein, POI may refer to the point of interface between a master communication unit operated by a team leader (ie. construction foremean or other) and an auxiliary communication device operated by a team member (ie. construction worker or other).

In a recent study, more than four million workers are injured every year, with nearly 5% of these workers killed due to job hazards, according to a report by the AFL-CIO; Death on the Job: The Toll of Neglect. On an average day, 15 workers lose their lives. In many cases, work place accidents may have been avoided if employers were able to quickly communicate information to employees regarding unseen hazards on the job. For example, construction workers erecting a large structure may be working in many different areas of a job site, with individuals working both inside and outside the structure. Should workers inside the structure become alerted to a collapsing support beam, they themselves may be able to quickly flee the building before it collapses, however they have no efficient way of alerting others on the job site to the impending danger. As such, those working in other areas inside the structure or in the close proximity to the exterior of the structure have no way of knowing that they are in harm's way and thus may be injured or killed as a result of the collapse.

Once an involved work project begins, a plurality of team members are typically assigned to different areas to work on various aspects of the project. It is important for all team members to remain in communication with a team leader to receive instructions and to be able to be immediately notified in the event of an emergency. Accordingly, the present invention, ready check communication systems 100, provides a plurality of position of interface (POI) devices comprising a novel, efficient and effective communication system, especially in the event of an emergency condition. It should be understood that the term “project” may be used herein to generally refer to a collaborative effort to accomplish a shared goal involving at least two individuals working in cooperative communication. In a typical project, the team leader (project manager) is tasked with the duty to oversee the project. Further, the team leader often has an added duty to protect the team members and the team project from foreseeable and unforeseeable danger. Team members usually are individually assigned a specific job. It should be understood that ready check communication systems 100 may be employed for a wide array of projects and may be adapted according to user-preference as per application.

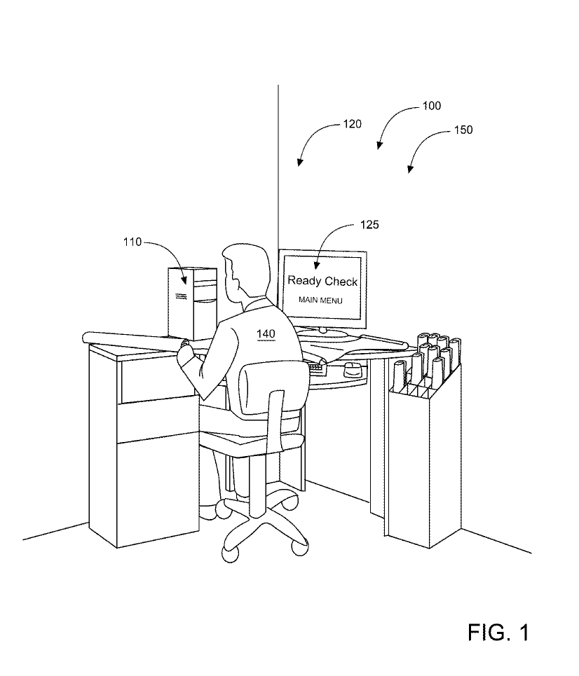

Referring to the drawings now by numerals of reference there is shown in FIG. 1, ready check communication systems 100 comprising central computer system 110 according to a preferred embodiment of the present invention. As shown, central computer system 110 may generally comprise computer assembly 120 for establishing and maintaining a secure remote network 725 between remotely connectable portable electronic devices comprising varying embodiments of ready check communications system 100. Further, central computer system 110 may be used to record activity of ready check communication systems 100.

As illustrated in FIG. 1, computer assembly 120 may generally comprise a computer processor, touch screen LCD monitor 125, operating memory, at least one hard drive for data storage, a plurality of input ports, including USB port 260, a keyboard, a mouse 9 or other suitable inputting means), and optimized software for installing, integrating, and maintaining ready check communication systems 100. In use, user 140 follows the detailed steps of operation in order to establish remote network 725. Central computer system 110 may be used to initially set the parameters defining remote network 725, to configure communication settings between master communication unit 200 and auxiliary communication device(s) 400, and to administer remote network 725. It should be appreciated that central computer system 110 may perform the same functions as master communication unit 200 with the prime distinction that master communication unit 200 is compact and portable and may be used remotely by team leader 142.

To establish or administer remote network 725, central computer station 110 may comprise a “Main Menu” displayable via touch screen LCD monitor 125 (or non-touch screen display means). User 140 may input data and make desired selections via touch screen LCD monitor 125 using a finger or stylus or alternatively by using a keyboard and mouse as been seen in FIG. 1.

“Main Menu” may comprise the options of “System Settings”, “Project Settings”, and “Diagnostics”. The date and time may be displayable at the top of touch screen LCD monitor 125 and additional options to shut down or restart central computer station 110 may be displayed toward the bottom of touch screen LCD monitor 125.

If user 140 selects “System Settings” via touch screen LCD monitor 125 or keyboard and mouse, a Systems Settings menu may appear providing the following options: 1) Set Date/Time; 2) Display Settings; and 3) Audio Options. Each of these options shall open a new menu thereby providing user 140 with the ability to modify system settings of central computer station 110 to a user-preferred state.

If user 140 selects “Project Settings” via touch screen LCD monitor 125 or keyboard and mouse, a Project Settings menu may appear providing the following options: 1) Set POI Count; and 2) Start Project. The POI Count controls the number of auxiliary communication devices 400 are initialized by central computer station 110 for the next project. If user 140 selects “Start Project”, the next project in the queue will be started serving to send a wireless signal to auxiliary communication devices 400 thereby setting auxiliary communication devices 400 to a “Not Ready” state.

If user 140 selects “Diagnostics” via touch screen LCD monitor 125 or keyboard and mouse, a Diagnostics menu may appear providing the following options: 1) Upload Firmware; 2) Transfer Logs; and 3) POI Test. When user 140 selects “Upload Firmware”, a screen may appear providing options to upload new firmware. New firmware may comprise software with pre-configured parameters for remote network 725 which may be uploaded to central computer station 110 wirelessly or via USB port 260 and may serve to apply system updates, fixes, and enhancements. When user 140 selects “Transfer Logs”, a screen may appear enabling log files to be transferred to a connected USB device in the form of a plain text file. The plain text file may then be reviewed to monitor activity of auxiliary communication device(s) 400 connected via remote network 725 to master communication unit 200. Further, when user 140 selects “POI Test”, a screen may appear providing user 140 with options to cycle through auxiliary communication device(s) 400 and toggle remote status LED 435 to verify that everything is functional. A ping tone may be played over speaker 335 for audio confirmation. Master communication unit 200 may further comprises a forward motion indicator and a keypad thereby providing an inputting and programming mean in certain embodiments.

A “Runtime Status” may be selected by user 140 in order to display the current status of auxiliary communication device(s) 400 on remote network 725. The POI device number corresponds to a “Docking Station” slot number, preferably labeled on outer surface of rechargeable power supplier 602 which was previously occupied by auxiliary communication device(s) 400. There may be up to 40 auxiliary communication device(s) 400 per each individual remote network 725. Any auxiliary communication device(s) 400 that have not been assigned to remote network 725 may appear as “Offline” on the “Runtime Status” screen. Further, the status of each auxiliary communication device(s) 400 is displayed. Additional indicators for loss of signal or low battery may also be displayed in preferred embodiments. It should be noted that removing auxiliary communication device(s) 400 from remote network 725 will immediately change the state of auxiliary communication device(s) 400 to “Offline”. Adding new auxiliary communication device(s) 400 will initialize auxiliary communication device(s) 400 to a “Not ready” state and will then be connected to remote network 725 for wireless communication with master communication unit 200 and other auxiliary communication device(s) 400 also connected to remote network 725. Auxiliary communication devices 400 preferably comprise a transponder, a plurality of multi-colored light emitting diodes, and at least one receiver. Transponder may be configured to at least one standard radio frequency sufficient to allow communication between master communication unit 200 and auxiliary communication devices 400 over remote network 725.

The “Runtime Status” screen may display an option for “Stop Project”. If user 140 selects “Stop Project”, which may be done at any time, the status of auxiliary communication device(s) 400 may be switched to “Done” thereby indicating that the project has been completed or has been indefinitely halted. However, the “Done” status of auxiliary communication device(s) 400 may be superseded during emergency condition 475 when hazard button 302 or EMS button 304 has been pushed on master communication unit 200 or auxiliary communication device(s) 400.

Further, the “Runtime Status” screen may display a “Go” option that will appear once all auxiliary communication device(s) 400 connected on remote network 725 displays a “Ready” state. Upon the selection of “Go”, auxiliary communication device(s) 400 will preferably shift to an “Active” state.

If user 140 selects auxiliary communication device(s) 400 on the “Runtime Status” screen, a new screen may be displayed comprising a context menu with an option to emit a ping tone via alert speaker 450 of auxiliary communication device(s) 400. This may be used as a convenient tool to locate a misplaced auxiliary communication device(s) 400. Since auxiliary communication device(s) 400 are intended to be carried at all times, this may assist with rapidly locating team member 144 who may have become disabled as a result of emergency condition 475. It should be appreciated that many other options and variations of use may be employed within the scope of the present invention and that the disclosed embodiments and methods are not meant to be limiting, but rather to enable ready check communication systems 100.

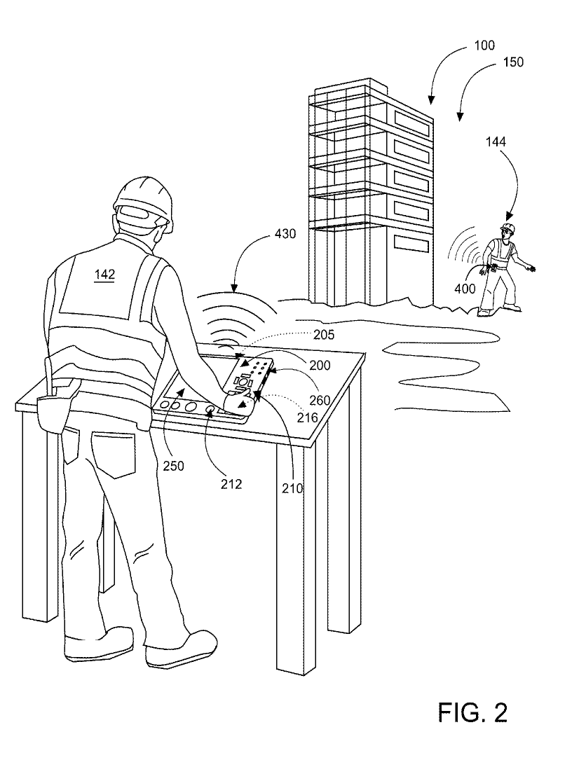

Referring now to FIG. 2, illustrating a perspective view of ready check communication systems 100 in an in-use condition 150. As depicted, master communication unit 200 is preferably operated by team leader 142, wherein team leader 142 may comprise a construction foreman, project manager or other such individual/entity charged with overseeing a construction or non-construction project. Team leader 142 may use master communication unit 200 to remotely communicate with auxiliary communication device(s) 400 operated by at team member(s) 144. In a preferred embodiment of the ready check communication systems 100, master communication unit 200 is in wireless communication with auxiliary communication device(s) 400 and central computer system 110 via remote network 500. As such, master communication unit 200 may be operated by team leader 142 who is in a position to monitor and coordinate with team member(s) 144 having auxiliary communication device(s) 400 to send and receive signals back and forth over remote network 725. In such a manner, master communication unit 200 may be utilized by team leader 142 to continuously transmit radio waves 430 comprising audible signals from master communication unit 200 to auxiliary communication device(s) 400 connected on remote network 725. Visible signals are also able to be transmitted in preferred embodiments, especially useful in noisy environments.

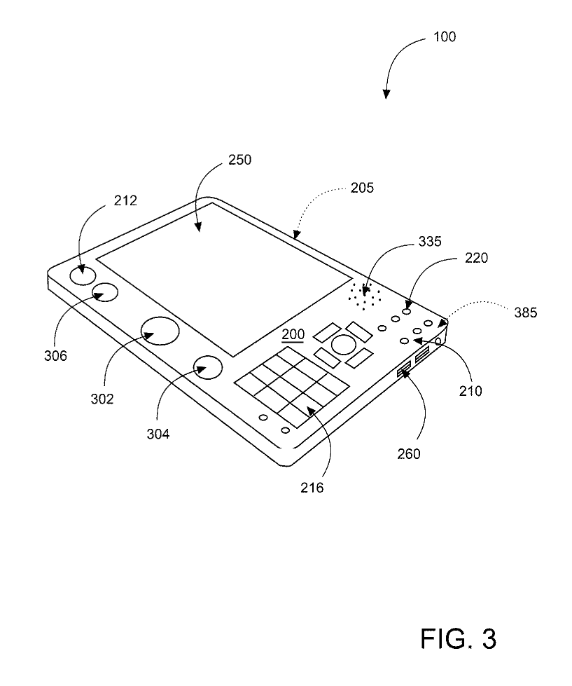

As illustrated in FIG. 3, master communication device 200 may integrally comprise wireless transceiver 205, speaker 335, and rechargeable battery power 385. Shown on the front surface of master communication device 200 is LCD screen 250 for displaying information and master communication unit interface 210 for inputting information and displaying alerts. Master communication unit interface 210 may comprise input buttons 212, keypad 216, and status LEDs 220. Further, master communication unit interface 210 may comprise hazard button 302, EMS button 304, and stop button 306 for convenient and rapid pushing means during an emergency condition 475.

In use, alert signals may be transmitted to auxiliary communication device(s) 400 configurably-linked via central computer system 110 over remote network 725 within range of radio waves 430 transmitted by wireless transceiver 205. It will be appreciated that in the preferred embodiment of the present invention, master communication device 200 comprises USB ports(s) 260 to aid in the configuration of ready check communication systems 100. In a preferred embodiment, wireless transceiver 205 of master communication unit 200 and auxiliary communication device 400 may be set to a standard radio frequency comprising a range of about three miles. In other embodiments ranges may be greater than or less than three miles.

It should further be appreciated that in a preferred embodiment of ready check communication systems 100, master communication unit 200 may integrally comprise a 115 dB audible chime with a distinct, programmable alarm sound which may be emitted via speaker 335 in the event of an emergency condition 475. Individuals using the present system will be trained as to what alarms indicate and to preferred actions based on these warnings.

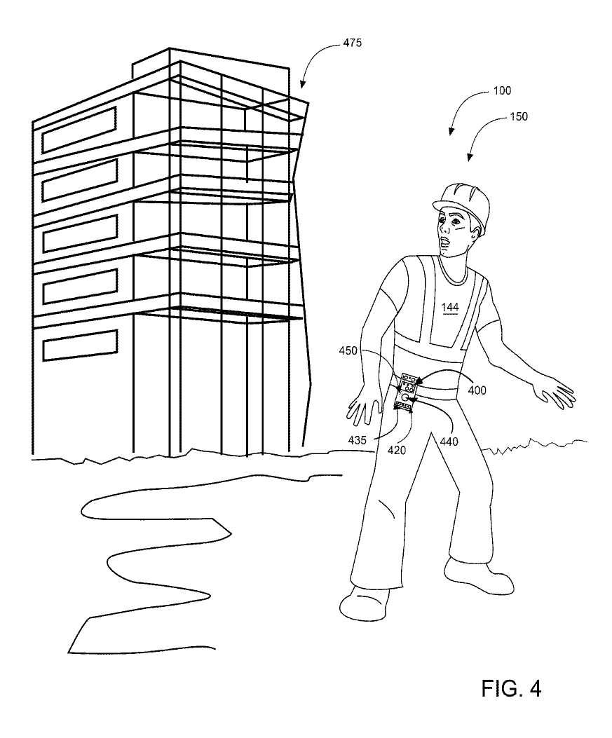

Master communication unit 200 may comprise a plurality of status LED 220 for indicating various levels of understood conditions. As shown best in FIGS. 3 and 4, master communication unit interface 210 may comprise status LED 220 labeled “battery” which may serve to indicate the battery life of master communication unit 200. In use, status LED 220 labeled “battery” remains unlit when master communication unit 200 is connected to rechargeable power supplier 602 or if battery life is greater than 25 percent. Status LED 220 labeled “battery” may be lit yellow when battery life is less than or equal to 25 percent and greater than 10 percent. Status LED 220 labeled “battery” may be lit red when battery life is less than or equal to 10 percent. Further, master communication unit 200 comprises status LED 220 labeled “signal” which may serve to indicate various signal statuses between master communication device 200 and other POI devices (auxiliary communication devices 400) connected within remote network 725. In use, status LED 220 labeled “signal” may be lit green to confirm that a signal is being received from master communication unit 200. Status LED 220 labeled “signal” may be lit yellow when ping from master communication unit 200 has not been received for a time period of 15 seconds. Status LED 220 labeled “signal” may be lit red when ping from master communication unit 200 has not been received for a time period of 35 seconds. In certain embodiments time periods may be user-set according to preference by team leader 142.

When master communication unit 200 is in a “Setup” state, status LEDs 220 may be unlit to indicate that the project has not been initialized and that no auxiliary communication device(s) 400 have been assigned. The “Setup” state may comprise a menu system displayable on LCD screen 250 of master communication unit 200 to guide user 140 through a process of initializing auxiliary communication device(s) 400. A plurality of input buttons 212 comprising directional buttons, an enter button, and keypad 216 are available to interact with the menu. A screen-by-screen breakdown of the menu system will be described in detail, however the main purpose of the menu is to set runtime configurations and project settings to govern the overall behavior of the system and establish parameters for ready check communication systems 100.

Once parameters are configured, an option to start the project may be displayed on LCD screen 250 and the requested number of auxiliary communication device(s) 400 may be initialized, thus shifting master communication unit 200 to a “Waiting” state. System settings may comprise: Date/Time Information; Noise Level (POI and Master Remote alert tones), POI Settings: number of auxiliary communication device(s) 400. It should be noted that the number of auxiliary communication device(s) 400 may not exceed 40 in this particular embodiment.

Project status LEDs 200 are lit yellow to indicate that all the initialized auxiliary communication device(s) 400 on remote network 725 have registered as “Self Ready”. LCD screen 250 will display an option to send the “Go” command to activate the project. If auxiliary communication device(s) 400 transmits a “Stop” notification, then the Team Project status will return to “Waiting”, status LEDs 200 of master communication unit interface 210 will be lit red, and the “Go” command option will not be available again until remote network 725 has been returned to the “Team Ready state”. It should be noted that central computer system 110 and master communication unit 200 both have the capability to send the “Go” command, however this option is available solely on master communication unit 200 it if is online, otherwise central computer system 110 will have sole control over this function. Once the “Go” command has been sent, remote network 725 will transition to the “Active” state. Emergency condition 475 may occur at any time and will clear the ready status of auxiliary communication device(s) 400 on remote network 725 and set the appropriate alert status LED 220. The central computer system 110 and master communication unit 200 also may trigger either status as necessary using hazard button 302 or EMS button 304 as best seen on FIG. 3.

In a “Go” condition of master communication unit 200, status LEDs 220 are lit green to indicate that all initialized auxiliary communication device(s) 400 on remote network 725 have been sent the “Go” command and that work has begun. LCD screen 250 of master communication unit 200 will continue to display the status of all connected auxiliary communication device(s) 400. If auxiliary communication device(s) 400 issues a “Stop” notification or stop button 306 is pressed on central computer system 110 or master communication unit 200, then the team project status will return to “Waiting”, status LEDs 220 will be lit red, and the “Go” command option will not be available again until remote network 725 has returned to the “Team Ready” state. Further, when “Stop” notification has been initiation by central computer system 110, master communication unit 200, or auxiliary communication device(s) 400, a high pitch alert tone will be emitted by all active devices on remote network 725 to ensure that user 140, team leader 142, and team member(s) 144 are aware of the condition. Emergency condition 475 may occur at any time and will clear the ready status of auxiliary communication device(s) 400 on remote network 725 and set the appropriate alert status LED 220. The central computer system 110 and master communication unit 200 also may trigger either status as necessary using hazard button 302 or EMS button 304.

In a “Hazard” condition of master communication unit 200, status LEDs 220 are lit yellow to indicate that a hazardous condition(s) has occurred which may have terminated the project. A hazardous condition may be transmitted via radio waves 430 by auxiliary communication device(s) 400 when team member 144 has pushed hazard button 302 indicating emergency condition 475. In order for work to continue, master communication unit 200 and auxiliary communication device(s) 400 connected via remote network 725 must be returned to rechargeable power supplier 602 to be reset. Once returned to rechargeable power supplier 602, status LEDs 220 of master communication unit interface 210 will return to an unlit condition thereby indicating that the project has stopped completely. Upon the occurrence of a hazardous condition, LCD screen 250 of master communication unit 200 will display auxiliary communication device(s) 400 that triggered the hazard notification so further inquiry may be made by team leader 142 to assess emergency condition 475. Further, a loud, repeating buzzer (or other such readily recognizable audible signal) may be emitted by speaker 335 of master communication unit 200 to ensure that team leader 142 is notified in a timely manner.

The loud, repeating buzzing noise/signal will continue until stop button 306 is pressed (activated) on either central computer system 110 or master communication unit 200. If auxiliary communication device(s) 400 have been lost or irreparably damaged, an option may be selected using central computer system 110 or LCD screen 250 of master communication unit 200 to orphan auxiliary communication device(s) 400 thereby deactivating the ID for that device and allowing for the initialization of a new project. A new set of POI device IDs may be created and ready check communication systems 100 prevent inactive IDs from interfering with the project.

In an “EMS” condition of master communication unit 200, status LEDs 220 are preferably lit (illuminated) blue to indicate that a serious injury has occurred which has terminated the project. In order for work to continue, master communication unit 200 and auxiliary communication device(s) 400 connected via remote network 725 must be returned to rechargeable power supplier 602 to be reset. Once returned to rechargeable power supplier 602, status LEDs 220 of master communication unit interface 210 will return to an unlit condition thereby indicating that the project has stopped completely. Upon the occurrence of an EMS condition, LCD screen 250 of master communication unit 200 will display auxiliary communication device(s) 400 that triggered the EMS notification so further inquiry may be made by team leader 142 to assess emergency condition 475. Further, a repeating, siren-like chime may be emitted by speaker 335 of master communication unit 200 to ensure that team leader 142 is notified in a timely manner. The repeating, siren-like chime will continue until stop button 306 is pressed on either central computer system 110 or master communication unit 200. If auxiliary communication device(s) 400 have been lost or irreparably damaged, an option may selected using central computer system 110 or LCD screen 250 of master communication unit 200 to orphan auxiliary communication device(s) 400 thereby deactivating the ID for that device and allowing for the initialization of a new project. A new set of POI device IDs may be created and ready check communication systems 100 prevent inactive IDs from interfering with the project.

In a “HEMS” condition of master communication unit 200, hazard status LEDs 220 are lit yellow and EMS status LEDs 220 are lit blue to indicate that a hazardous condition has been identified and a serious injury has occurred which has terminated the project. In order for work to continue, master communication unit 200 and auxiliary communication device(s) 400 connected via remote network 725 must be returned to rechargeable power supplier 602 to be reset. Once returned to rechargeable power supplier 602, status LEDs 220 of master communication unit interface 210 will return to an unlit condition thereby indicating that the project has stopped completely. Upon the occurrence of a HEMS condition, LCD screen 250 of master communication unit 200 will display auxiliary communication device(s) 400 that triggered the HEMS notification so further inquiry may be made by team leader 142 to assess emergency condition 475. Further, a repeating, siren-like chime may be emitted by speaker 335 of master communication unit 200 to ensure that team leader 142 is notified in a timely manner. The repeating, siren-like chime will continue until stop button 306 is pressed on either central computer system 110 or master communication unit 200. As mentioned above, if auxiliary communication device(s) 400 have been lost or irreparably damaged, an option may selected using central computer system 110 or LCD screen 250 of master communication unit 200 to orphan auxiliary communication device(s) 400 thereby deactivating the ID for that device and allowing for the initialization of a new project. A new set of auxiliary communication device(s) 400 IDs may be created and ready check communication systems 100 prevent inactive auxiliary communication device(s) 400 IDs from interfering with the project.

As illustrated in FIG. 4, team member 144 comprising a construction worker is alarmed due to emergency condition 475. As shown, auxiliary communication device 400 may be equipped with auxiliary communication device clip 410 comprising a spring loaded clip fastener or comparable mechanism for suitably removably securing auxiliary communication device 400 to team member 144 on outerwear or belt. In such a fashion, team member 144 shall always have ready access to auxiliary communication device 400.

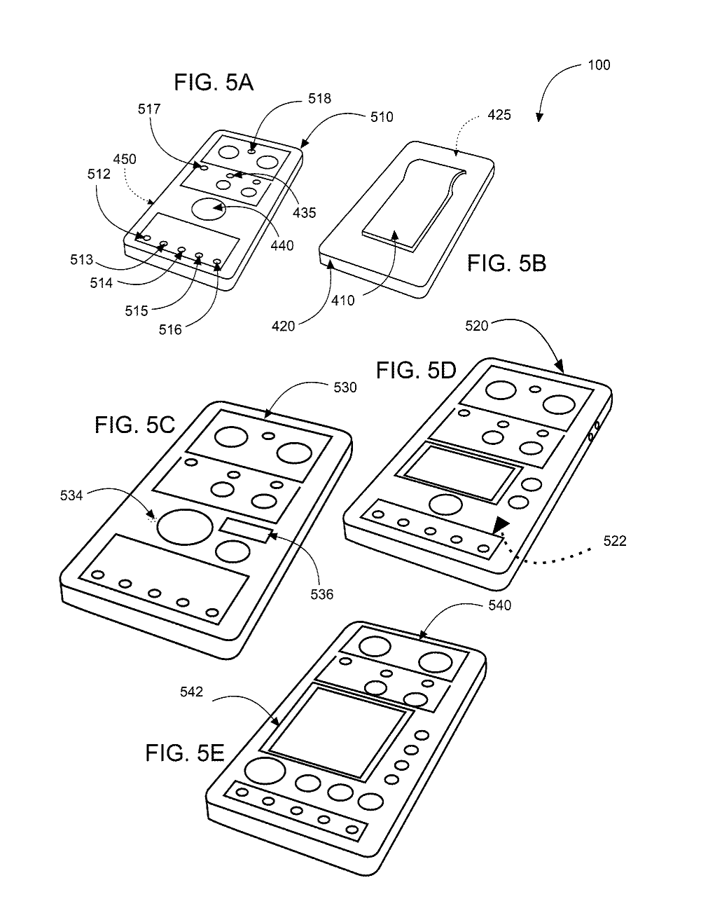

As best shown in FIGS. 4 and 5A-5E, auxiliary communication device 400 may integrally comprise remote transmitter 425, alert speaker 450, and a rechargeable power supply. Auxiliary communication device 400 may further comprise POI interface 460 comprising a plurality of remote status LEDs 435 and remote buttons 440. Auxiliary communication device 400 may preferably be housed within protective casing 420 preferably manufactured using a shatterproof, military-grade plastic material to withstand impact. Other materials may be used within alternate embodiments.

When user 140 is operating auxiliary communication device 400, radio waves 430 may be transmitted over remote network 725 between auxiliary communication device 400 and master communication unit 200 or between at least two or more auxiliary communication devices 400 operated by other team members 144. When remote buttons 440 are pushably activated by user 140, an alert signal comprising radio waves 430 is wirelessly transmitted via integrated remote transmitter 425. Further, auxiliary communication device 400 comprises alert speaker 450 with audio producing means. In use, alert speaker 450 may emit a short chime comprising a 2-5 second sequence indicating “Go”. Alert speaker 450 may emit a solid, high pitch horn comprising a 2-3 second duration indicating “Stop”. Alert speaker 450 may emit a repeating buzzer (buzzing noise) with a configurable duration of between 15-60 seconds indicating “Hazard”. Alert speaker 450 may emit a repeating, siren-like chime sequence indicating “EMS”. Alert speaker 450 may emit a voice message “Return to Docking Station” indicating “Return” until auxiliary communication device 400 is docked into rechargeable power supplier 602.

As mentioned previously auxiliary communication device 400 comprises a plurality of remote status LEDs 435 indicating various levels of real-time conditions. In a preferred embodiment of auxiliary communication device 400, remote status LEDs 435 comprise red LED 512 indicating a stop or a failure condition, blue LED 513 indicating an EMS condition, yellow LED 514 indicating a hazard or a warning condition, and green LED 515 indicating a positive condition. It should be noted that an inactive condition may be indicated when all remote status LEDs 435 are unlit. It should be noted that remote status LEDs 435 will remain unlit while auxiliary communication device 400 is connected to rechargeable power supplier 602 until initiated by master communication unit 200. It should also be noted that LED colors may be inter-changed or other colors substituted and still be considered as a suitable equivalent intended to be within the scope of the invention.

POI interface 460 of auxiliary communication device 400 comprises a first status section labeled “MY STATUS” and a second status section labeled “TEAM STATUS”. The section labeled “MY STATUS” may be located toward the top of POI interface 460 of auxiliary communication device 400 and may comprise remote buttons 440, and remote status LED 435 for indicating the present status of auxiliary communication device 400. Beneath the first status section is the second status section labeled “TEAM STATUS” and may comprise remote buttons 440 and remote status LEDs 435 indicating the present status of a plurality of auxiliary communication device(s) 400 connected via remote network 725. The team status section may be used to indicate whether all auxiliary communication device(s) 400 are in a “Ready” or “Not Ready” state. Further, remote status LEDs 435 may comprise “TEAM STATUS” indicator, “Hazard” indicator, and “EMS” indicator. Each LED may be activated when remote buttons 440 are pushed by user 140. When remote status LED 435 is lit green, auxiliary communication device 400 is in a “ready” condition. When remote status LED 435 is lit red, auxiliary communication device 400 is in a “not ready” condition. Only when every individual auxiliary communication device 400 connected via remote network 725 is in the “ready” condition will “TEAM STATUS” remote status LED 435 be lit green. If emergency condition 475 arises, radio waves 430 transmitting signal alerts for “Hazard” and “EMS” remote status LEDs 435 will clear the POI interface 460 to a default mode.

Auxiliary communication device 400 will be in an “Active” state when status remote status LEDs 435 are illuminated green indicating that all other auxiliary communication device(s) 400 linked on remote network 725 are ready and have received the “Go” command. All remote status LEDs 435 are lit green to provide redundancy in the event that a particular remote status LED 435 is not functional so that all units begin working at once. A chime tone may be played via alert speaker 450 as an added measure to ensure that all team members 144 receives the signal at once. When remote button 440 comprising a stop button is activated by user 140, auxiliary communication device(s) 400 linked on remote network 725 will revert to the “not ready” state. A high pitched tone is emitted via alert speaker 450 serving to alert all team members 144 that at least one other team member 144 may not be looking at his/her auxiliary communication device 400. Loss of signal for more than 30 seconds may cause master communication unit 200 to stop all activity in the same manner.

During a crisis or emergency, POI interface 460 may be switched to a “Hazard” state wherein hazard remote status LED 435 is illuminated yellow to visually indicate emergency condition 475. In order for work to continue, auxiliary communication device(s) 400 connected via remote network 725 must be returned to rechargeable power supplier 602 to be reset. “MY STATUS” remote status LED is lit red to indicate “not ready” status of auxiliary communication device 400. Further, “TEAM STATUS” remote status LEDs 435 are now unlit. A loud, repeating buzzer is emitted via alert speaker 450 to ensure that all auxiliary communication device(s) 400 connected via remote network 725 receive the notification as soon as possible and a pre-determined emergency response protocol may be followed. It should be further noted that no other action is possible from POI interface 460 once emergency condition 475 has occurred. Information about auxiliary communication device 400 that triggered the hazard notification will be logged by master communication unit 200 for evaluation and will also be shown on master communication unit 200 and master communication unit interface 210 at runtime for rapid assessment of situations.

Further, POI interface 460 of auxiliary communication device 400 may be switched to an “EMS” state wherein EMS remote status LED 435 is lit blue to indicate that a serious injury has occurred resulting in an emergency condition 475. In order for work to continue, all auxiliary communication device(s) 400 connected via remote network 725 must be returned to rechargeable power supplier 602 to be reset. “MY STATUS” remote status LED is lit red to indicate “not ready” status of auxiliary communication device 400. Further, “TEAM STATUS” remote status LEDs 435 are now unlit. A loud, repeating buzzing noise is emitted via alert speaker 450 to effectively ensure that all auxiliary communication device(s) 400 connected via remote network 725 receive the notification as soon as possible thereby preventing further injury. It should be noted that no other action is possible from auxiliary communication device 400 once this condition has occurred. Information about auxiliary communication device 400 that triggered the hazard notification will be logged by master communication unit 200 for evaluation and will also be shown on master communication unit 200 and master communication unit interface 210 at runtime for rapid assessment of situations.

POI interface 460 of auxiliary communication device 400 may be switched to a “HEMS” state wherein both “Hazard” remote status LED 435 is lit yellow and “EMS” remote status LED 435 is lit blue thereby indicating to team member 144 that a serious injury has occurred and that a hazardous condition has been identified. Although the two conditions may not be related, this is not necessarily the case allowing for another auxiliary communication device 400 connected on remote network 725 to register an “EMS” or “Hazard” condition at the same time. In order for work to continue, all auxiliary communication device(s) 400 connected via remote network 725 must be returned to rechargeable power supplier 602 to be reset. “MY STATUS” remote status LED is lit red to indicate “not ready” status of auxiliary communication device 400. A repeating, siren-like chime is emitted via alert speaker 450 to ensure that all auxiliary communication device(s) 400 connected via remote network 725 receive the notification as soon as possible thereby preventing further injury. It should be noted that no other action is possible from auxiliary communication device 400 once this condition has occurred. Information about auxiliary communication device 400 that triggered the hazard notification will be logged by master communication unit 200 for evaluation and will also be shown on master communication unit 200 and master communication unit interface 210 at runtime for rapid assessment of situations.

POI interface 460 of auxiliary communication device 400 may be switched to a “Done” state wherein remote status LED 435 is lit red, similar to the “Not Ready” state, and a repeating message is emitted via alert speaker 450 informing user 140 to return auxiliary communication device 400 to rechargeable power supplier 602. This provides a standard manner whereby team leader 142 may terminate a project at a preferred discretion. Further, battery LED 517 and signal LED 518 will still operate normally until auxiliary communication device 400 has been returned to rechargeable power supplier 602.

As further shown in FIGS. 5A-5E, auxiliary communication device 400 may comprise battery LED 517 which may serve to indicate the battery life of auxiliary communication device 400. In use, battery LED 517 remains unlit when auxiliary communication device 400 is connected to rechargeable power supplier 602 or if battery life is greater than 25 percent. Battery LED 517 may be lit yellow when battery life is less than or equal to 25 percent and greater than 10 percent. Battery LED 517 may be lit red when battery life is less than or equal to 10 percent.

Auxiliary communication device 400 further comprises signal LED 518 which may serve to indicate various signal statuses between auxiliary communication device 400 and other devices connected within remote network 725. In use, signal LED 518 may be lit green to confirm that a signal is being received from master communication unit 200. Signal LED 518 may be lit yellow when ping from master communication unit 200 has not been received for a time period of 15 seconds. Signal LED 518 may be lit red when ping from master communication unit 200 has not been received for a time period of 35 seconds.

In the present invention, various versions of auxiliary communication device 400 are available as described previously and subsequently. As specifically shown in FIG. 5A, auxiliary communication device 400 may comprise a position of interface (POI) version 1 (POI version 1 510), wherein POI version 1 510 comprises red light emitting diode 512 indicating an emergency condition, blue light emitting diode 513 indicating an EMS condition, yellow light emitting diode 514 indicating a hazard or warning condition, and green light emitting diode 515 for indicating a positive condition. FIG. 5B illustrates a rear perspective of auxiliary communication device 400 comprising protective casing 420 and auxiliary communication device clip 410. It should be appreciated that in alternative embodiments of the present invention, various fastening devices may be used to affix auxiliary communication device 400 to a plurality of objects and apparel.

In another embodiment as shown in FIG. 5C, auxiliary communication device 400 may comprise a position of interface (POI) version 2 520 wherein POI version 2 520 comprises auxiliary communication device 400 that includes an integrated Global Positioning Satellite (GPS) device (at least herein embodying GPS microchip 522) with auto-updating means for logging coordinates into a last known location, and a separate communications frequency for open band voice communication with master communication unit 200 and other of auxiliary communication device(s) 400 over remote network 725.

In another embodiment as shown in FIG. 5D, auxiliary communication device 400 may comprise a position of interface (POI) version 3 (POI version 3 530) wherein said POI version 3 530 comprises auxiliary device 400 that may include atmospheric sensors for indicating air quality conditions, a biometric reading indicator, and a notifier automatically sent to at least one emergency service agency subject to prior arrangement and application setup of at least one emergency service agency. In this way the present invention may be in communication to notify at least one emergency service agency of a real-time condition, such that the response time may be decreased, thereby increasing the likelihood of survival of an injured individual.

In yet another embodiment as shown in FIG. 5E, auxiliary communication device 400 may comprise a position of interface (POI) version 4 (POI version 4 540) wherein POI version 4 540 comprises auxiliary communication device 400 that includes police, fire, military application for personnel tracking and GPS logging systems using GPS microchip 522 providing real time reporting, in-field computer integration means, and auto signal data packet sending means, wherein the auto signal data packet sending means automatically transmits last known information concerning a location of at least one auxiliary communication device 400. In this way the present invention may enhance location-finding of an injured individual within a shortened time period. In this way the present invention is usable for a variety of applications in various industries/occupations/projects.

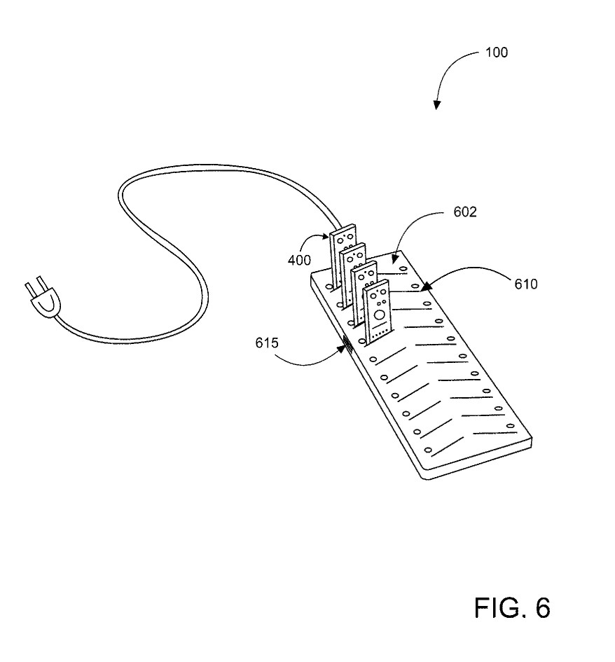

Referring now to FIG. 6, illustrating rechargeable power supplier 602 according to a preferred embodiment of ready check communication systems 100. As shown, rechargeable power supplier 602 may comprise docking station(s) 610 for receiving auxiliary communication device(s) 400. Rechargeable power supplier 602 preferably comprises at least one multi-pin adapter wherein auxiliary communication devices 400 are removably received and recharged thereby. In a preferred embodiment, rechargeable power supplier 602 may comprise docking station(s) 610 for receiving up to 40 auxiliary communication device(s) 400. Auxiliary communication devices 400 are ascendingly stackable in a diagonal manner, as indicated in the present figure in rechargeable power supplier 602. Rechargeable power supplier 602 may further comprise USB port 615 thereby providing a USB connection via rechargeable power supplier 602 and central computer system 110 or via rechargeable power supplier 602 and master communication unit 200. Rechargeable power supplier 602 further comprises a 120 volt standard receptacle plug for recharging (as shown).

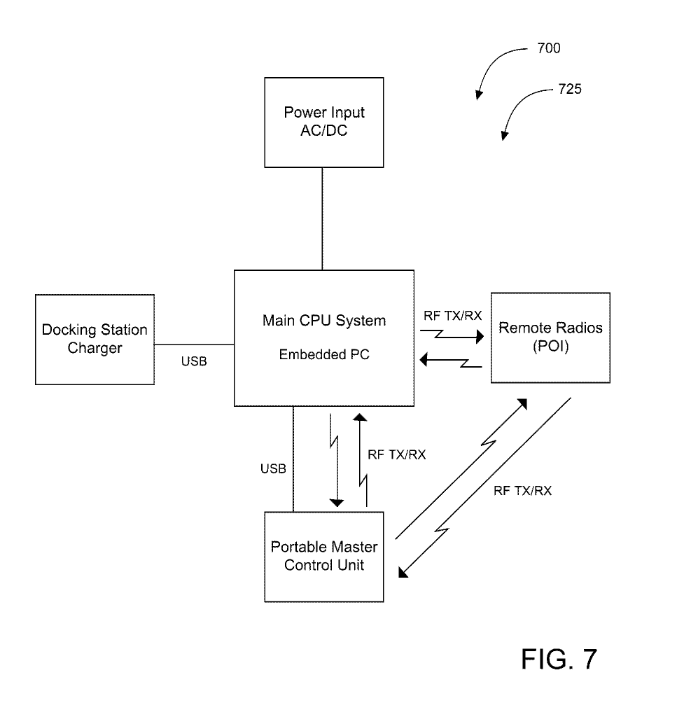

Referring now to FIG. 7, illustrating network flowchart 700 of ready check communication systems 100. As shown, power may be supplied by AC and/or DC means for providing operating power to central computer system 110. Once remote network 725 is configured by user 140, a plurality of connections may be initialized either remotely via a wireless connection over remote network 725 or via USB connection between various POI devices as essentially described herein. As shown in network flowchart 700, central computer system 110 may comprise a means to control all devices. As best seen in FIG. 7, auxiliary communication device(s) 400 are in wireless connection/communication with central computer system 110, master communication unit 200, and auxiliary communication device(s) 400 over remote network 725. Master communication unit 200 is also in wireless communication with auxiliary communication device(s) 400 and central computer system 110, and may also be in direct communication with central computer system 110 via a USB cable. Rechargeable power supplier 602 may only be connected to central computer station 110 via USB means.

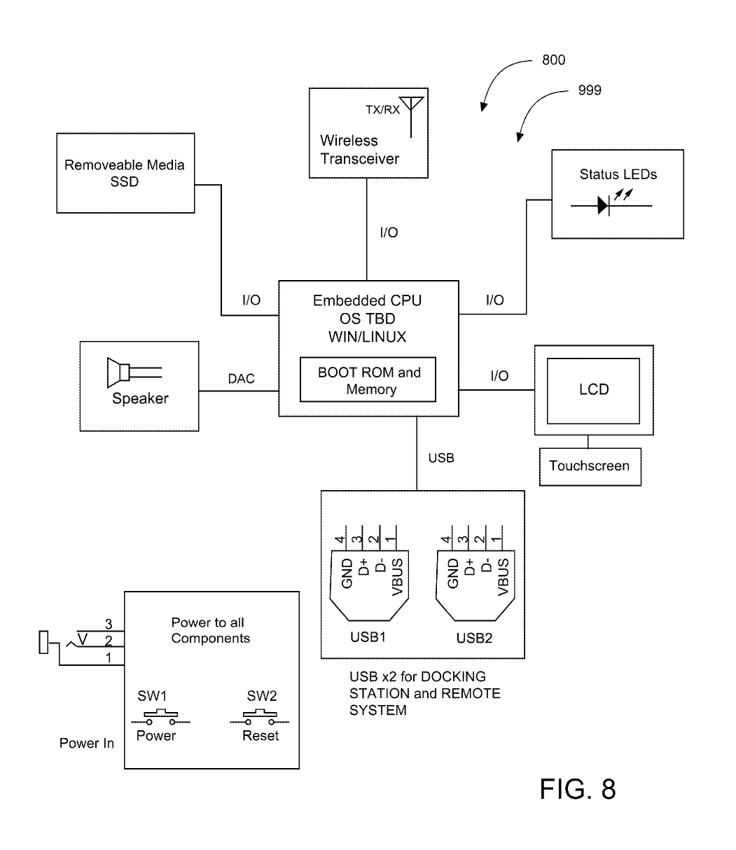

Referring now to FIG. 8, illustrating CPU system flowchart 800 according to a preferred embodiment of the present invention. As shown, central computer system 110 may comprise an embedded computer processor that may operate on a Windows, Linux, or other comparable server for establishing remote network 725. Central computer system 110 may comprise touch screen LCD monitor 125 for inputting data and information, a wireless transceiver for transmitting radio signals, a speaker, removable media, system memory and disk space, and USB ports for receiving rechargeable power supplier 602 or master communication unit 200.

Ready check communication systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other contents or arrangements such as, for example, including more or less components, customized parts, different color combinations, parts may be sold separately, etc., may be sufficient.

Further, upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready check communication system comprising:
a central computer system;
at least one remote master communication unit administered by a team leader;
a plurality of auxiliary communication devices operated by at least one team member;
at least one rechargeable power supplier;
wherein said central computer system creates parameters for a remote network;
wherein said remote master communication unit is in wireless communication with said central computer system and with said plurality of auxiliary communication devices such that at least one real-time safety related condition may be communicated via said remote network visually and audibly to a plurality of individuals;
wherein said at least one master communication unit and said plurality of auxiliary communication devices may be rechargeably powered by said at least one rechargeable power supplier; and
wherein said ready check communication system includes a network whereby said team leader is able to monitor and communicate via said central computer system or remotely via said at least one master communication unit with said at least one team member via said auxiliary communication device(s).

2. The ready check communication system of claim 1, wherein said central computer system comprises a computer assembly comprising at least one computer processor, a LCD monitor having touch screen capability, at least one operating memory card, at least one hard drive, a plurality of USB printer and audio/visual input ports, a keyboard, a mouse, and ready check optimized software for installing, integrating, and maintaining said ready check communication systems.

3. The ready check communication system of claim 1, wherein said master communication unit and said auxiliary communication device(s) comprise USB ports for use and calibration of said parameters of said master communication unit and said auxiliary communication device(s).

4. The ready check communication system of claim 1, wherein said master communication unit further comprises a wireless transceiver and a wireless transmitter enabling wireless communication with said central computer system and with said auxiliary communication device(s) over said remote network.

5. The ready check communication system of claim 1, wherein said master communication unit further comprises a liquid crystal display and a plurality of status LED(s) providing a visual status indication of said auxiliary communication devices.

6. The ready check communication system of claim 1, wherein said master communication unit further comprises a forward motion indicator and a keypad thereby providing an inputting and programming means.

7. The ready check communication system of claim 1, wherein said auxiliary communication devices comprise a transponder, a plurality of multi-colored light emitting diodes, and at least one receiver.

8. The ready check communication system of claim 7 wherein said auxiliary communication devices further comprise at least one spring loaded clip fastener for removably securing at least one said auxiliary communication device to said at least one team member.

9. The ready check communication system of claim 7, wherein said auxiliary communication device is in configurable communication with said master communication unit and at least one other said auxiliary communication device over said remote network.

10. The ready check communication system of claim 7, wherein said transponder is configured to at least one standard radio frequency sufficient to allow communication between said master communication unit and said auxiliary communication devices over said remote network wherein said remote network comprises a distance of about three miles.

11. The ready check communication system of claim 7, wherein said light emitting diodes comprise at least one red, blue, yellow, and green said light emitting diode for visually indicating at least one said real-time safety related condition.

12. The ready check communication system of claim 11, wherein said auxiliary communication device comprises a position of interface (POI) version 1 wherein said POI version 1 comprises said red light emitting diode indicating an emergency condition, said blue light emitting diode indicating an EMS condition, said yellow light emitting diode indicating a hazard or warning condition, and said green light emitting diode for indicating a positive condition.

13. The ready check communication system of claim 11, wherein at least one said auxiliary communication device comprises a position of interface (POI) version 2 wherein said POI version 2 comprises said auxiliary device that includes an integrated Global Positioning Satellite (GPS) device with auto-updating means for logging coordinates into a last known location, and a separate communications frequency for open band voice communication with said master control unit and other said auxiliary communication device(s) over said remote network.

14. The ready check communication system of claim 11, wherein at least one said auxiliary communication device comprises a position of interface (POI) version 3 wherein said POI version 3 comprises said auxiliary device that includes atmospheric sensors for indicating air quality conditions, a biometric reading indicator, and a notifier automatically sent to at least one emergency service agency subject to prior arrangement and application setup of said at least one emergency service agency.

15. The ready check communication system of claim 11, wherein at least one said auxiliary communication device comprises a position of interface (POI) version 4 wherein said POI version 4 comprises said auxiliary device that includes police, fire, military application for personnel tracking and GPS logging systems providing real time reporting, in-field computer integration means, and auto signal data packet sending means, wherein said auto signal data packet sending means automatically transmits last known information concerning a location of said at least one auxiliary communication device.

16. The ready check communication system of claim 7, wherein said auxiliary communication device comprises impact resistant, military grade plastic material.

17. The ready check communication system of claim 1 further comprising a rechargeable power supplier comprising at least one multi-pin adapter wherein said auxiliary communication device are received and recharged thereby.

18. The ready check communication system of claim 17, wherein said auxiliary communication device are ascendingly stackable in a diagonal manner in said rechargeable power supplier.

19. The ready check communication system of claim 17, wherein said rechargeable power supplier further comprises a 120 volt standard receptacle plug for recharging.

20. The ready check communication system of claim 17, wherein said rechargeable power supplier further comprises a USB adapter recharger for POI designation.
